(19) United States
(12) Patent Application Publication
(10) Pub. No.: US 2004/0108444 A1
(43) Pub. Date: Jun. 10, 2004

(54) Apparatus for making foundation walls having angled or arcuate contours

(76) Inventor: Jerome A. Cohen, Henderson, NV (US)

Correspondence Address: Richard R. Michaud, McCormick, Paulding & Huber LLP, CityPlace II, 185 Asylum Street, Hartford, CT, 06103, US

(21) Appl. No.: 10/643,496

(22) Filed: Aug. 19, 2003

Related U.S. Application Data
(60) Provisional application No. 60/404,623, filed on Aug. 19, 2002.

(51) Int. Cl. E04B 1/346; E04B 7/16; B41B 11/54; E04G 9/00

(52) U.S. Cl. 249/170; 52/71

(57) ABSTRACT

In an apparatus for making foundation walls having angled or arcuate contours first and second connecting members are provided. Each connecting member defines at least one joining portion, the connecting members being attachable to a foundation form. When foundation forms are positioned adjacent to one another the joining portions defined by each of the connecting members interlock with one another. An elongating coupling member defining an exterior shape complementary to a shape defined by passages extending through the joining portions is positioned in these passages to rotatably and releasably join the first and second connecting members and thereby the foundation forms together.

### CROSS-REFERENCE TO RELATED APPLICATIONS

This application is entitled to the benefit of and incorporates by reference essential subject matter disclosed in Provisional Patent Application No. 60/404,623 filed on Aug. 19, 2002.

### FIELD OF THE INVENTION

The present invention is generally directed to forms useful in fabricating foundations, and is more specifically directed to a device for rotatably and releasably coupling adjacent foundation forms together.

### BACKGROUND OF THE INVENTION

The construction of most foundation walls is accomplished using masonry units, generally concrete blocks, or poured concrete both of which are set on concrete footings. In general, foundation walls are straight and meet at right angles to one another. However, sometimes it is desirable, for purposes of design and aesthetics, to create angled or curved foundation walls. Typically, these are constructed by either incrementally changing the orientation of each masonry unit and filling in the open joints with concrete. The masonry units can be custom cut, however, this is costly and labor intensive.

Poured concrete walls require the use of foundation forms which are positioned in accordance with a desired wall shape and thickness. In residential construction, the forms are usually made from wood. Snap ties space the foundation forms and provide for attachment of one form to another. A problem occurs when angled walls are desired because the standard snap ties cannot be properly employed to join the foundation forms. Accordingly, the foundation forms are tied together using steel strapping and require additional bracing. When curved walls are desired, the foundation forms historically have been custom cut to match the desired contour. This results in significant expense and increases in time. As such, contractors are reluctant to fabricate angled or curved foundation walls.

Based on the foregoing, it is the general object of the present invention to provide an apparatus useful in the fabrication of curved or angled foundation walls that overcomes or improves upon the prior art.

### SUMMARY OF THE INVENTION

The present invention resides in one aspect to an apparatus for making foundation walls having angled or arcuate contours. The apparatus includes first and second connecting members, each defining at least one joining portion. Each of the first and second connecting members is couplable to an end of a foundation form. Accordingly, when the forms are positioned adjacent to one another the joining portions defined by each of the connecting members interlock with one another. Each joining portion defines a shaped passage extending there through, the shaped passages defined by each of the first and second connecting members are substantially coaxial with one another when mating foundation forms are operably positioned adjacent to one another. An elongated coupling member defining an exterior shape complimentary to a shape defined by the shaped passages is slidably received in the shaped passages thereby rotatably and releasably joining the first and second connecting members and thereby the foundation forms together.

In the preferred embodiment of the present invention, at least one spacer is coupled to each of the foundation forms and located so that when the first and second connecting members are positioned on respective foundation forms, the spacer acts as a stop to properly locate each of the connecting members. Preferably, each of the first and second connecting members defines a channel for slidably receiving an end of one of the foundation forms. Attaching means are also included for securing the first and second connecting members to the foundation forms.

Preferably, the attaching means include a plurality of apertures extending through each of the first and second connecting members, each aperture being sized to receive and allow a fastener to extend there through. In the preferred embodiment of the present invention, the apertures are in the form of “T” shaped slots to allow the first and second connecting members to be slidably attached to the foundation forms via pre-installed fasteners projecting outwardly from the foundation forms.

### BRIEF DESCRIPTION OF THE DRAWINGS

FIG. 1 is a partial perspective view of a plurality of foundation forms retained together by the apparatus of the present invention.

FIG. 2 is a partial side elevational view of a pair of foundation forms retained together by the apparatus of the present invention.

FIG. 3 is a partial cross-sectional view of the pair of foundation forms retained together by the apparatus of the present invention shown in FIG. 2, taken along line 3-3 of FIG. 2.

FIG. 4 is a side view showing the first and second connecting members and the “U” shaped spacers.

FIG. 4A shows a flat spacer.

### DETAILED DESCRIPTION OF THE PREFERRED EMBODIMENT

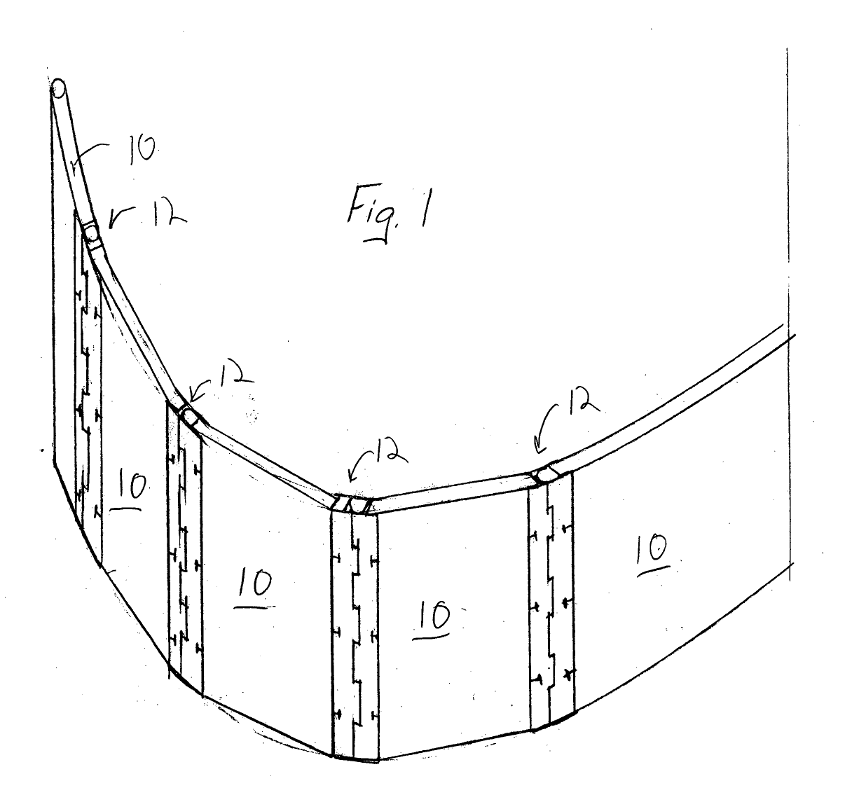

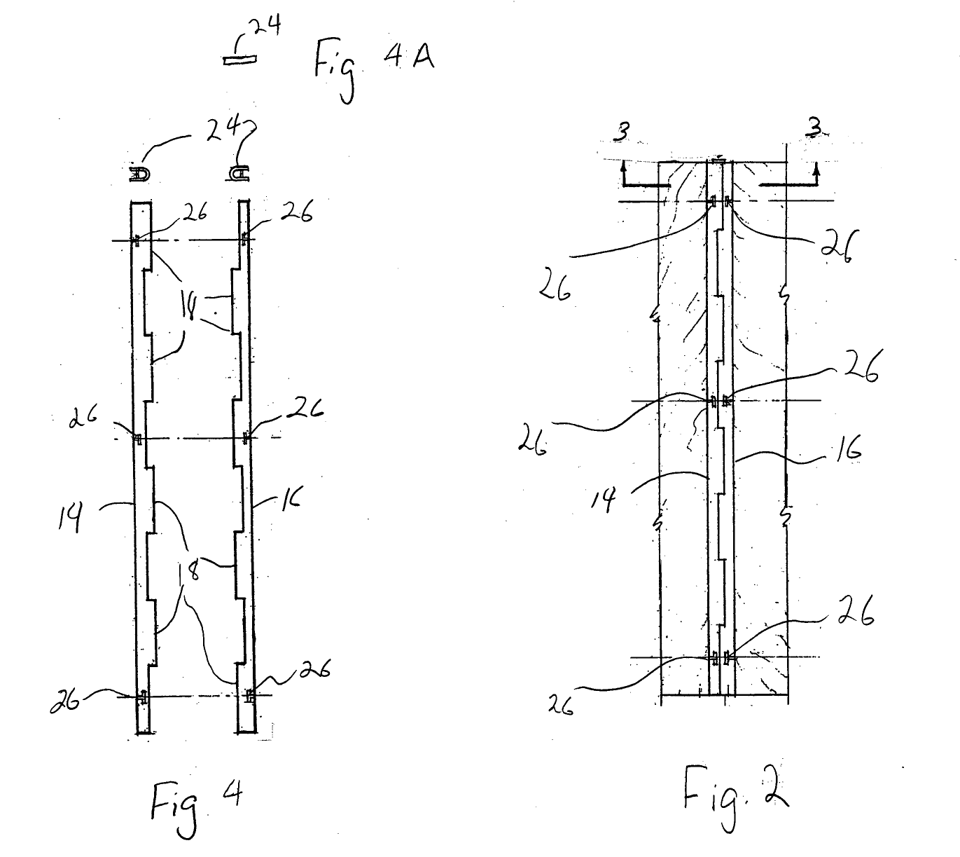

As shown in FIGS. 1-4, a plurality of foundation forms 10 are rotatably connected to one another via the apparatus of the present invention, generally designated by the reference number 12. The apparatus 12 includes first and second connecting members, 14 and 16 respectively, each attached, as will be explained in detail below, to one of the foundation forms 10. Each of the first and second connecting members, 14 and 16 respectively, define outwardly projecting joining portions 18. Each joining portion 18 defines a shaped passage 20 extending there through. When each of the connecting members 14, 16 is attached to a foundation form 10 and the forms are operably positioned adjacent to one another, the joining portions 18 interlock, as is best seen by reference to FIG. 2. Once the joining portions 18 are interlocked, the shaped passages 20 defined by each are substantially coaxial.

Referring to FIG, 3, an elongated coupling member 22 defining an exterior shape complimentary to a shape defined by said shaped passages 20 is slidably received therein. The elongated coupling member is shown in the illustrated embodiment as a pipe, however, the present invention is not limited in this regard as a solid bar can also be employed without departing from the broader aspects of the present invention. In order to allow for the proper positioning of the first and second connecting members, 14 and 16 respectively, spacers 24 are positioned between the foundation forms. The spacers 24 can be “U” shaped as shown in FIG. 4 or they can be substantially flat, as shown in FIG. 4A.

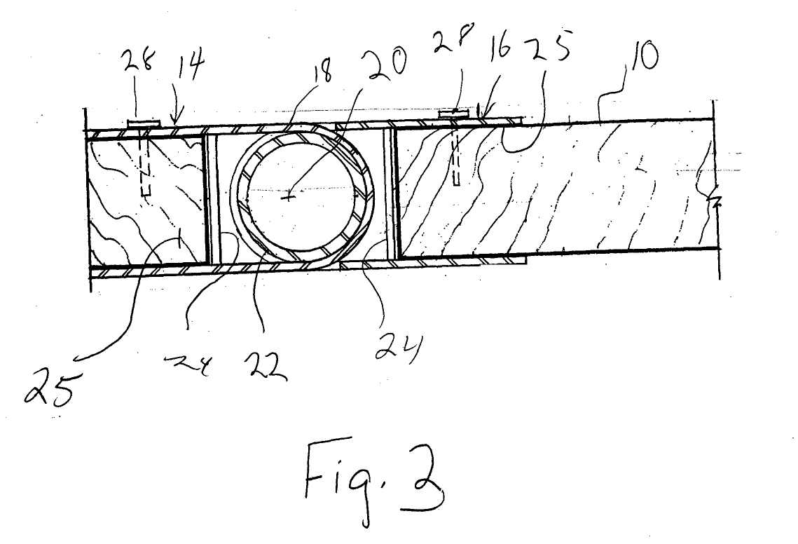

The first and second connecting members, 14 and 16 respectively, each define a channel 25 adapted to receive an end of a foundation form 10, and apertures 26, shown in the illustrated embodiment as “T” shaped slots, are provided for receiving a fastener 28 to couple the foundation forms 10 to the connecting members. The fasteners 28, FIG. 3, can be preinstalled and the connecting members 14 and 16 slid over them via the slots 26, or they can be installed once the connecting members are positioned.

During operation, the connecting members 14 and 16 are installed on the foundation forms 10 and the forms positioned adjacent one another so that the joining portions 18 interlock. The elongated coupling member 22 is then slid through the passages 20, thereby rotatably coupling the foundation forms 10 together. The forms can then be positioned to form a desired contour. While the connecting members have been described as separate components that must be attached to the foundation forms, the present invention is not limited in this regard as the connecting members can be an integral part of the foundation form without departing from the broader aspects of the present invention.

While preferred embodiments have been shown and described, various modifications and substitutions may be made without departing from the spirit and scope of the present invention. Accordingly, it is to be understood that the present invention has been described by way of example, and not by limitation.

What is claimed is:

1. An apparatus for making foundation walls having angled or arcuate contours comprising:
first and second connecting members, each defining at least one joining portion, each of said first and second connecting members being coupable to an end of a foundation form so that when said forms are operably positioned adjacent to one another said joining portions defined by each of said connecting members interlock with one another;
each joining portion defines a shaped passage extending there through, said shaped being substantially coaxial with one another when said first and second connecting members are operably positioned;
an elongated coupling member defining an exterior shape complimentary to a shape defined by said shaped passages;
is sidably received in said shaped passages thereby rotatably and releasably joining said first and second connecting members and thereby said foundation forms together.

2. An apparatus as defined by claim 1, further comprising: at least one spacer coupled to each of said foundation forms and located so that when said first and second connecting members are positioned on respective foundation forms, said spacer acts as a stop to properly locate each of said connecting members.

3. An apparatus defined by claim 1, wherein each of said first and second connecting members defines a channel, said end of said foundation form being slidably receivable in said channel.

4. An apparatus as defined by claim 3, further comprising attaching means for securing said first and second connecting members to said foundation forms.

5. An apparatus as defined by claim 4, wherein the attaching means includes a plurality of apertures extending through each of the first and second connecting members, each for receiving a fastener therein.

6. An apparatus as defined by claim 4, wherein the attaching means includes a plurality of slots extending through each of the first and second connecting members, each for receiving a fastener therein.

7. An apparatus as defined by claim 6, wherein said slots are “T” shaped to allow said first and second connecting members to be slidably attached to said foundation forms via pre-installed fasteners projecting outwardly from said foundation forms.

8. An apparatus as defined by claim 1, wherein each of said first and second connecting members is integral with a respective foundation form.

9. An apparatus as defined by claim 2, wherein said at least one spacer is approximately flat and extends between said foundation forms.

10. An apparatus as defined by claim 2, wherein said spacer is “U” shaped and extends between said foundation forms.
